(19) United States
(12) Patent Application Publication
(10) Pub. No.: US 2019/0373362 A1
(43) Pub. Date: Dec. 5, 2019

(54) PATTERN-FORMING MICROPHONE ARRAY

(71) Applicant: Shure Acquisition Holdings, Inc., Niles, IL (US)

(72) Inventors: Michelle Michiko Ansai, Chicago, IL (US); John Casey Gibbs, Chicago, IL (US); Mathew T. Abraham, Colorado Springs, CO (US)

(21) Appl. No.: 16/409,239

(22) Filed: May 10, 2019

Related U.S. Application Data
(60) Provisional application No. 62/679,452, filed on Jun. 1, 2018.

(51) Int. Cl. H04R 1/40; H04R 19/04; H04R 3/00; H04R 3/04

(52) U.S. Cl. CPC H04R 1/406; H04R 19/04; H04R 2201/003; H04R 3/04; H04R 3/005

(57) ABSTRACT

Embodiments include a microphone array with a plurality of microphone elements comprising a first set of elements arranged along a first axis, comprising at least two microphone elements spaced apart by a first distance; a second set of elements arranged along the first axis, comprising at least two microphone elements spaced apart by a second, greater distance, such that the first set is nested within the second set; a third set of elements arranged along a second axis orthogonal to the first axis, comprising at least two microphone elements spaced apart by the second distance; and a fourth set of elements nested within the third set along the second axis, comprising at least two microphone elements spaced apart by the first distance, wherein each set includes a first cluster of microphone elements and a second cluster of microphone elements spaced apart by the specified distance.

### CROSS-REFERENCE TO RELATED APPLICATIONS

This application claims priority from U.S. Provisional Application Ser. No. 62/679,452, filed on Jun. 1, 2018, the content of which is incorporated herein by reference in its entirety.

### TECHNICAL FIELD

This application generally relates to microphone arrays. In particular, this application relates to a microphone array configurable to form one or more desired polar patterns.

### BACKGROUND

In general, microphones are available in a variety of sizes, form factors, mounting options, and wiring options to suit the needs of a given application. There are several different types of microphones and related transducers, such as, for example, dynamic, crystal, condenser/capacitor (externally biased and electret), Micro-Electrical-Mechanical-System (“MEMS”), etc., each having its advantages and disadvantages depending on the application. The different microphones can be designed to produce different polar response patterns, including, for example, omnidirectional, cardioid, subcardioid, supercardioid, hypercardioid, and bidirectional. The polar pattern chosen for a particular microphone (or microphone cartridge included therein) may depend on, for example, where the audio source is located, the desire to exclude unwanted noises, and/or other considerations.

In conferencing environments, such as boardrooms, video conferencing settings, and the like, one or more microphones are used to capture sound from multiple audio sources. The audio sources may include in-room human speakers, and in some cases, loudspeakers for playing audio received from human speakers that are not in the room, for example. The captured sound may be disseminated to an audience through loudspeakers in the environment, a telecast, a webcast, telephony, etc. The types of microphones and their placement in a particular conferencing environment may depend on the locations of the audio sources, the loudspeakers, physical space requirements, aesthetics, room layout, and/or other considerations. For example, in some environments, the microphones may be placed on a table or lectern near the audio sources. In other environments, the microphones may be mounted overhead to capture the sound from the entire room, for example.

Some existing conferencing systems employ boundary microphones and button microphones that can be positioned on or in a surface (e.g., a table). Such microphones typically include multiple cartridges so that the microphones can have multiple independent polar patterns to capture sound from multiple audio sources (e.g., human speakers seated at different sides of a table). Other such microphones may include multiple cartridges so that various polar patterns can be formed by appropriately processing the audio signals from each cartridge, thus eliminating the need to physically swap cartridges to obtain a different polar pattern. For these types of microphones, while it would be ideal to co-locate the multiple cartridges within the microphone, so that each cartridge detects sounds in the environment at the same instant, it is not, however, physically possible to do so. As such, these types of microphones may not uniformly form the desired polar patterns and may not ideally capture sound due to frequency response irregularities, as well as interference and reflections within and between the cartridges.

In most conferencing environments, it is desirable for a microphone to have a toroidal polar pattern that is omnidirectional in the plane of the microphone with a null in the axis perpendicular to that plane. For example, a toroidal microphone that is positioned on a conference table may be configured to detect sound in all directions along the plane of the table, but minimize the detection of sound above the microphone, e.g., in the direction pointing towards the ceiling and/or away from the table. However, existing microphones with toroidal polar patterns may be physically large, have a high self-noise, require complex processing, and/or have inconsistent polar patterns over a full frequency range, e.g., 100 Hz to 10 kHz.

Micro-Electrical-Mechanical-System (“MEMS”) microphones, or microphones that have a MEMS element as the core transducer, have become increasingly popular due to their small package size (e.g., allowing for an overall lower profile device) and high performance characteristics (e.g., high signal-to-noise ratio (“SNR”), low power consumption, good sensitivity, etc.). In addition, MEMS microphones are generally easier to assemble and available at a lower cost than, for example, electret or condenser microphone cartridges found in many existing boundary microphones. However, due to the physical constraints of the MEMS microphone packaging, the polar pattern of a conventional MEMS microphone is inherently omnidirectional, which means the microphone is equally sensitive to sounds coming from any and all directions, regardless of the microphone's orientation. This can be less than ideal for conferencing environments, in particular.

One existing solution for obtaining directionality using MEMS microphones includes placing multiple microphones in an array configuration and applying appropriate beamforming techniques (e.g., signal processing) to produce a desired directional response, or a beam pattern that is more sensitive to sound coming from one or more specific directions than sound coming from other directions. Such microphone arrays may have different configurations and frequency responses depending on the placement of the microphones relative to each other and the direction of arrival for sound waves. For example, a broadside microphone array includes a line of microphones arranged perpendicular to the preferred direction of sound arrival. The output for such arrays is obtained by simply summing the resulting microphone signals together, thus producing a flat and on-axis response.

As another example, an endfire array includes multiple microphones arranged in-line with the desired direction of sound propagation. In a differential endfire array, the signal captured by the front microphone in the array (i.e. the first microphone reached by sound propagating on-axis) is summed with an inverted and delayed version of the signal captured by the rear microphone in the array (i.e. positioned opposite the front microphone) to produce cardioid, hypercardioid, or supercardioid pickup patterns, for example. In such cases, the sound from the rear of the array is greatly or completely attenuated, while the sound from the front of the array has little or no attenuation. The frequency response of a differential endfire array is not flat, so an equalization filter is typically applied to the output of the differential beamforming algorithm to flatten the response. While MEMS microphone endfire arrays are currently in use, specifically in the handset and hearing health industries, the existing products do not provide the high performance characteristics required for conferencing platforms (e.g., maximum signal-to-noise ratio (SNR), planar directional pickup, wideband audio coverage, etc.).

Accordingly, there is still a need for a low profile, high performing microphone array capable of forming one or more directional polar patterns that can be isolated from unwanted ambient sounds, so as to provide full, natural-sounding speech pickup suitable for conferencing applications.

### SUMMARY

The invention is intended to solve the above-noted and other problems by providing a microphone array that is designed to, among other things, provide (1) at least one linear microphone array comprising one or more sets of microphone elements nested within one or more other sets, each set including at least two microphones separated by a distance selected to cover a desired operating band; (2) a beamformer configured to generate a combined output signal for the linear array having a desired directional polar pattern (e.g., toroidal, cardioid, etc.); and (3) high performance characteristics suitable for conferencing environments, such as, e.g., a highly directional polar pattern, high signal-to-noise ratio (SNR), wideband audio coverage, etc.

For example, one embodiment includes a microphone array with a plurality of microphone elements comprising: a first set of elements arranged along a first axis and comprising at least two microphone elements spaced apart from each other by a first distance, and a second set of elements arranged along the first axis and comprising at least two microphone elements spaced apart from each other by a second distance greater than the first distance, such that the first set is nested within the second set, wherein the first distance is selected for optimal microphone operation in a first frequency band, and the second distance is selected for optimal microphone operation in a second frequency band that is lower than the first frequency band.

Another example embodiment includes a method of assembling a microphone array, the method comprising: forming a first set of microphone elements along a first axis, the first set including at least two microphone elements spaced apart from each other by a first distance; forming a second set of microphone elements along the first axis, the second set including at least two microphone elements spaced apart from each other by a second distance greater than the first distance, such that the first set is nested within the second set; and electrically coupling each microphone element to at least one processor for processing audio signals captured by the microphone elements, wherein the first distance is selected for optimal microphone operation in a first frequency band, and the second distance is selected for optimal microphone operation in a second frequency band that is lower than the first frequency band.

Exemplary embodiments also include a microphone system comprising: a microphone array including a plurality of microphone elements coupled to a support, the plurality of microphone elements comprising first and second sets of elements arranged along a first axis of the support, the first set being nested within the second set, wherein the first set includes at least two microphone elements spaced apart from each other by a first distance selected to configure the first set for optimal microphone operation in a first frequency band, and the second set includes at least two microphone elements spaced apart from each other by a second distance that is greater than the first distance, the second distance being selected to configure the second set for optimal microphone operation in a second frequency band that is lower than the first frequency band; a memory configured to store program code for processing audio signals captured by the plurality of microphone elements and generating an output signal based thereon; and at least one processor in communication with the memory and the microphone array, the at least one processor configured to execute the program code in response to receiving audio signals from the microphone array, wherein the program code is configured to: receive audio signals from each microphone element of the microphone array; for each set of elements along the first axis, combine the audio signals for the microphones in the set to generate a combined output signal with a directional polar pattern; and combine the combined output signals for the first and second sets to generate a final output signal for all of the microphone elements on the first axis.

Yet another exemplary embodiment includes a method performed by one or more processors to generate an output signal for a microphone array comprising a plurality of microphone elements coupled to a support. The method comprises: receiving audio signals from the plurality of microphone elements, the plurality of microphone elements comprising first and second sets of elements arranged along a first axis of the support, the first set being nested within the second set, wherein the first set includes at least two microphone elements spaced apart from each other by a first distance selected to configure the first set for optimal microphone operation in a first frequency band, and the second set includes at least two microphone elements spaced apart from each other by a second distance that is greater than the first distance, the second distance being selected to configure the second set for optimal microphone operation in a second frequency band that is lower than the first frequency band; for each set of elements along the first axis, combining the audio signals for the microphone elements in the set to generate a combined output signal with a directional polar pattern; and combining the combined output signals for the first and second sets to generate a final output signal for all microphone elements on the first axis.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a schematic diagram illustrating an exemplary microphone array in accordance with one or more embodiments.

FIG. 2 is a schematic diagram illustrating design considerations for the microphone array of FIG. 1 in accordance with one or more embodiments.

FIG. 3 is a schematic diagram illustrating another exemplary microphone array in accordance with one or more embodiments.

FIG. 4 is a schematic diagram illustrating still another exemplary microphone array in accordance with one or more embodiments.

FIG. 5 is a block diagram of an exemplary microphone system in accordance with one or more embodiments.

FIG. 6 is a block diagram illustrating an exemplary pattern-forming beamformer for combining audio signals captured by a given set of microphone elements, in accordance with one or more embodiments.

FIG. 7 is a block diagram illustrating an exemplary pattern-combining beamformer for combining audio outputs received from nested sets of microphone elements, in accordance with one or more embodiments.

FIG. 8 is a flowchart illustrating an exemplary method performed by an audio processor to generate a beamformed output signal with a directional polar pattern for a microphone array comprising at least one linear nested array, in accordance with one or more embodiments.

FIG. 9 is a frequency response plot of an exemplary microphone array in accordance with one or more embodiments.

FIG. 10 is a noise response plot of an exemplary microphone array in accordance with one or more embodiments.

### DETAILED DESCRIPTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

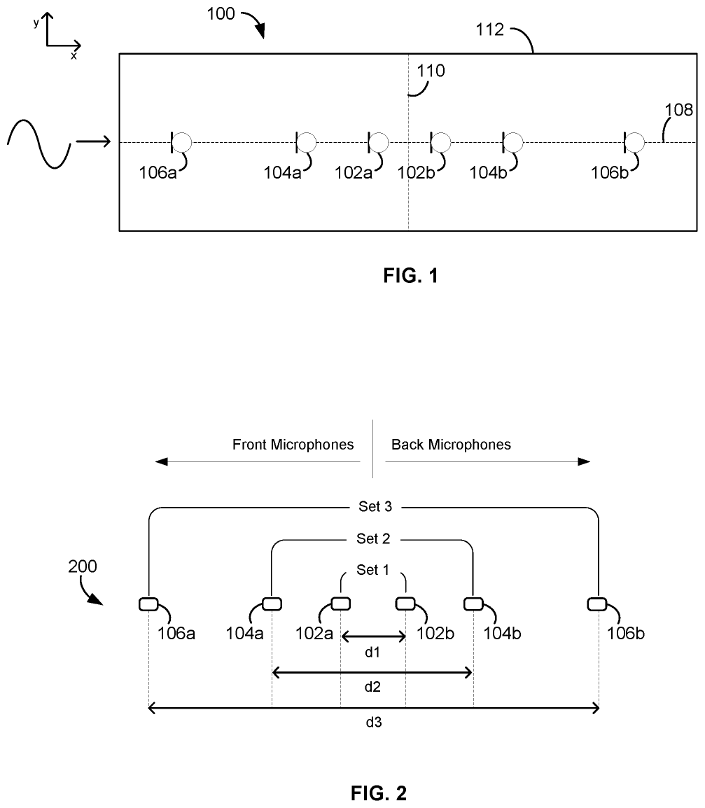

Systems and methods are provided herein for a high performing microphone comprising at least one linear array with multiple pairs (or sets) of microphone elements spaced apart by specified distances and arranged in a nested configuration to achieve coverage of desired operating bands, a high signal-to-noise ratio (SNR), and a directional polar pattern. Exemplary embodiments also include a microphone with at least two orthogonal linear arrays having a shared center and symmetrical placement of microphone elements on each axis to create a planar directional pickup pattern. Embodiments further include linear arrays in which at least one of the microphone pairs (or sets) comprise spaced apart clusters of two or more microphone elements to create a higher sensitivity microphone with an improved SNR. In preferred embodiments, the microphone elements are MEMS transducers or other omnidirectional microphones. These and other array forming features are described in more detail herein, particularly with respect to FIGS. 1 to 4.

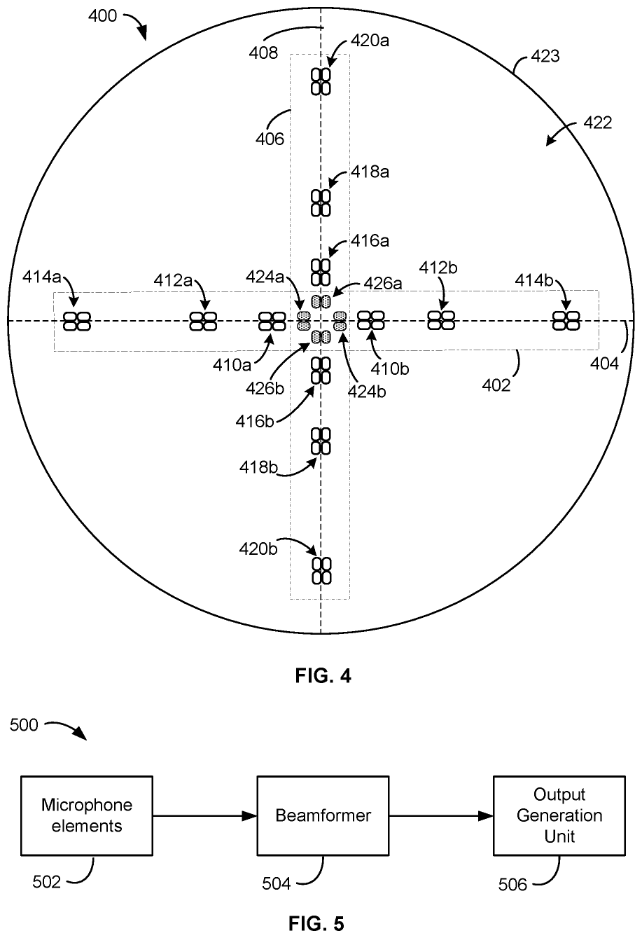

Embodiments also include one or more beamformers for combining the polar patterns for each set of microphone elements on a given axis and then summing the combined outputs for the various sets to obtain a final output with a directional polar pattern (such as, e.g., cardioid, etc.). In the case of orthogonal linear arrays, the beamformers can combine the final outputs for each axis to achieve planar directional pickup (such as, e.g., toroidal, etc.). In some embodiments, the one or more beamformers use crossover filtering to isolate each set of microphone elements to its optimal frequency band (or range) and then sum or stitch together the outputs of each set to obtain a desired frequency response that covers all or most of the audible bandwidth (e.g., 20 Hz to 20 kHz) and has a higher SNR than, for example, that of the individual microphone elements. These and other beamforming techniques are described in more detail herein, particularly with respect to FIGS. 5 to 8.

FIG. 1 illustrates an exemplary microphone 100 comprising a microphone array that can detect sounds from one or more audio sources at various frequencies, in accordance with embodiments. The microphone 100 may be utilized in a conferencing environment, such as, for example, a conference room, a boardroom, or other meeting room where the audio source includes one or more human speakers. Other sounds may be present in the environment which may be undesirable, such as noise from ventilation, other persons, audio/visual equipment, electronic devices, etc. In a typical situation, the audio sources may be seated in chairs at a table, although other configurations and placements of the audio sources are contemplated and possible, including, for example, audio sources that move about the room. The microphone 100 can be placed on a table, lectern, desktop, etc. in order to detect and capture sound from the audio sources, such as speech spoken by human speakers.

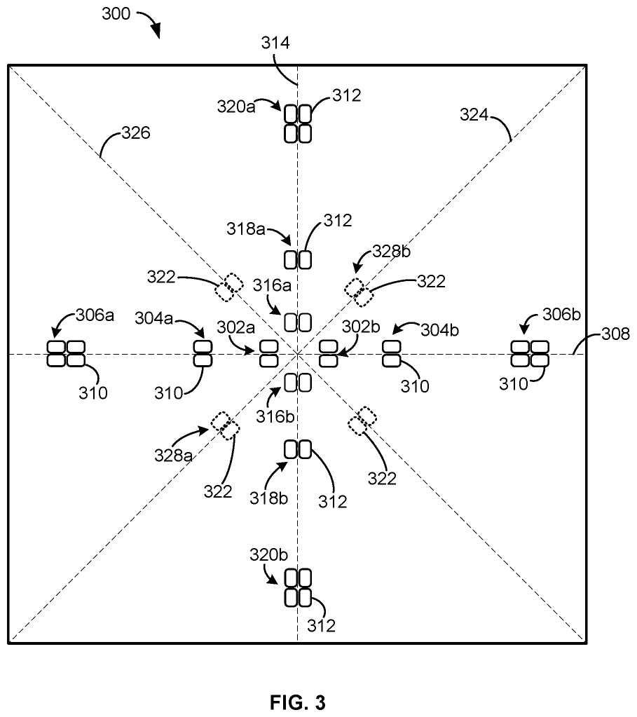

The microphone array of microphone 100 is comprised of multiple microphone elements 102a,b, 104a,b, 106a,b that can form multiple pickup patterns for optimally detecting and capturing the sound from said audio sources. In FIG. 1, the microphone elements 102a,b, 104a,b, 106a,b are generally arranged in a linear fashion along a length of the microphone 100. In embodiments, the microphone elements 102a,b, 104a,b, 106a,b may be disposed along a common axis of the microphone 100, such as, e.g., a first axis 108. In the illustrated embodiment, the first axis 108 coincides with an x-axis of the microphone 100, which passes through, or intersects with, a y-axis (e.g., second axis 110) of the microphone 100 at a common central point (or midpoint). In other cases, the first axis 108 may be parallel to the x-axis and vertically offset from the central point of the microphone 100 (e.g., above or below the center). In still other cases, the first axis 108 may be angled relative to both the x-axis and the y-axis so as to form a diagonal line there between (see, e.g., FIG. 3). In some cases, the microphone array includes microphone elements arranged along a y-axis (e.g., second axis 110) of the microphone 100 (not shown), instead of the first axis 108.

Although FIG. 1 shows six microphone elements 102a,b, 104a,b, 106a,b, other numbers (e.g., larger or fewer) of microphone elements are possible and contemplated, for example, as shown in FIGS. 3 and 4. The polar patterns that can be formed by the microphone 100 may include omnidirectional, cardioid, subcardioid, supercardioid, hypercardioid, bidirectional, and/or toroidal. In some embodiments, each of the microphone elements 102a,b, 104a,b, 106a,b of the microphone 100 may be a MEMS (micro-electrical mechanical system) transducer with an inherent omnidirectional polar pattern. In other embodiments, the microphone elements 102a,b, 104a,b, 106a,b may have other polar patterns, may be any other type of omnidirectional microphone, and/or may be condenser microphones, dynamic microphones, piezoelectric microphones, etc. In still other embodiments, the arrangement and/or processing techniques described herein can be applied to other types of arrays comprised of omnidirectional transducers or sensors where directionality is desired (such as, e.g., sonar arrays, radio frequency applications, seismic devices, etc.).

Each of the microphone elements 102a,b, 104a,b, 106a,b in the microphone 100 can detect sound and convert the sound into an audio signal. In some cases, the audio signal can be a digital audio output. For other types of microphone elements, the audio signal may be an analog audio output, and components of the microphone 100, such as analog to digital converters, processors, and/or other components, may process the analog audio signals to ultimately generate one or more digital audio output signals. The digital audio output signals may conform to the Dante standard for transmitting audio over Ethernet, in some embodiments, or may conform to another standard. In certain embodiments, one or more pickup patterns may be formed by the processor of the microphone 100 from the audio signals of the microphone elements 102a,b, 104a,b, 106a,b, and the processor may generate a digital audio output signal corresponding to each of the pickup patterns. In other embodiments, the microphone elements 102a,b, 104a,b, 106a,b of the microphone 100 may output analog audio signals and other components and devices (e.g., processors, mixers, recorders, amplifiers, etc.) external to the microphone 100 may process the analog audio signals.

The microphone 100 may further include a support 112 (such as, e.g., a substrate, printed circuit board, frame, etc.) for supporting the microphone elements 102a,b, 104a,b, 106a,b. The support 112 may have any size or shape including, for example, a rectangle (e.g., FIG. 1), square (e.g., FIG. 3), circle (e.g., FIG. 4), hexagon, etc. In some cases, the support 112 may be sized and shaped to meet the constraints of a pre-existing device housing and/or to achieve desired performance characteristics (e.g., select operating bands, high SNR, etc.). For example, a maximum width and/or length of the microphone array may be determined by the overall width of a device housing.

In embodiments, each of the microphone elements 102a,b, 104a,b, 106a,b is mechanically and/or electrically coupled to the support 112. For example, in the case of a PCB, the microphone elements 102a,b, 104a,b, 106a,b may be electrically coupled to the support 112, and the PCB/support 112 may be electrically coupled to one or more processors or other electronic device for receiving and processing audio signals captured by the microphone elements 102a,b, 104a,b, 106a,b. In some embodiments, the microphone elements 102a,b, 104a,b, 106a,b are embedded into or physically located on the support 112. In other embodiments, the microphone elements 102a,b, 104a,b, 106a,b may be suspended from (e.g., dangling below) the support 112 using, for example, a plurality of wires respectively coupled between the microphone elements 102a,b, 104a,b, 106a,b and the support 112. In still other embodiments, each of the microphone elements 102a,b, 104a,b, 106a,b of the microphone 100 may not be physically connected to each other or a specific support, but may be wirelessly connected to a processor or audio receiver so as to form a distributed network of microphones. In such cases, the microphone elements 102a,b, 104a,b, 106a,b may be individually arranged on, or suspended from, one or more surfaces within the conferencing environment or table, for example.

In FIG. 1, the microphone elements 102a,b, 104a,b, 106a,b are arranged in the same plane and on the same surface or side of the support 112 (e.g., a front or top surface). In other embodiments, the microphone 100 also includes one or more microphones (not shown) arranged on an opposite side or surface (e.g., back or bottom surface) of the support 112 (see, e.g., FIG. 4), so as to increase the total number of microphone elements included in the microphone array and/or to enable the microphone 100 to cover more frequency bands.

In some embodiments, the microphone 100 comprises additional microphone elements (not shown) arranged along one or more other axes of the microphone 100 (see, e.g., FIG. 3). In such cases, the other axes, like the second axis 110, for example, may intersect with the first axis 108 at the center or midpoint of the microphone 100 and may be co-located in the same plane as the first axis 108 (see, e.g., FIGS. 3 and 4). The placement of additional microphone elements on such other axes having a shared center can, among other things, enable or enhance the ability to achieve planar directionality for the output of the microphone 100, as described herein.

According to embodiments, the microphone elements 102a,b, 104a,b, 106a,b of the microphone 100 can be arranged in a nested configuration made up of various sets or groups of microphone elements. This configuration is further illustrated in FIG. 2, which depicts a microphone array 200 comprised of the microphone elements 102a,b, 104a,b, 106a,b shown in FIG. 1. As shown in FIG. 2, a first set 102 (“Set 1”) includes the microphone elements 102a and 102b spaced apart from each other by a first distance d1 that is the smallest or nearest distance of the three sets; a second set 104 (“Set 2”) includes the microphone elements 104a and 104b spaced apart from each other by a second distance d2 that is greater than the first distance, or the middle or intermediate distance of the three sets; and a third set 106 (“Set 3”) includes the microphone elements 106a and 106b spaced apart from each other by a third distance d3 that is greater than the second distance, or the largest or furthest distance of the three sets. The nested configuration can be achieved by placing the microphone elements 106a,b of Set 3 at the outer ends of the microphone array 200, placing or nesting the microphone elements 104a,b of Set 2 within the microphone elements 106a,b of Set 3, and placing or nesting the microphone elements 102a,b of Set 1 within the microphone elements 104a,b of Set 2. While three nested groups are shown in FIGS. 1 and 2, other numbers of nested groups (and microphone elements) are possible and contemplated (e.g., as shown in FIGS. 3 and 4). For example, the exact number of nested groups may depend on the desired number of operating bands for the microphone array 200 and/or the physical constraints of a device housing.

According to embodiments, the distance between the respective microphone elements within a given set 102, 104, or 106 can be selected to optimally cover a desired frequency band or range (also referred to herein as “operating band”). In particular, Set 1 (including microphone elements 102a,b) may be configured to cover a first or higher frequency band, Set 2 (including microphone elements 104a,b) may be configured to cover a second or middle frequency band (or range), and Set 3 (including microphone elements 106a,b) may be configured to cover a third or lower frequency band (or range). In some cases, the spacing between the elements in the middle Set 2, and therefore, the frequency band coverage provided thereby, may be selected to bridge the gap between the high frequency band covered by Set 1 and the low frequency band covered by Set 3 and/or to keep a noise level of the microphone array output low. In embodiments, appropriate beamforming techniques may be utilized to combine the outputs of the different sets 1, 2, and 3, so that the overall microphone 100 achieves a desired frequency response, including, for example, lower noise characteristics, higher microphone sensitivity, and coverage of discrete frequency bands, as described in more detail herein.

In the illustrated embodiment, each of the nested groups 102, 104, 106 includes at least one front microphone element 102a, 104a, or 106a and at least one back microphone element 102b, 104b, or 106b, respectively, arranged in a linear endfire array. That is, the microphone elements in each set are arranged in-line with the direction of on-axis sound propagation, such that sound reaches the front microphone elements 102a, 104a, or 106a before reaching the corresponding back microphone elements 102b, 104b, or 106b. Due to this linear configuration, the sound picked up by the different microphone elements in each of the Sets 1, 2, and 3 may differ only in terms of arrival time. In embodiments, appropriate beamforming techniques may be applied to the microphone elements 102a,b, 104a,b, 106a,b so that each of the nested Sets 1, 2, 3 effectively operates as independent microphone arrays having a desired directional pickup pattern and frequency response characteristics, as described in more detail herein (see, e.g., FIGS. 5-7). In some embodiments, the “front” and “back” designations may be programmatically assigned by the processor depending on the design considerations for the microphone 100. In one example embodiment, the processor can flip the “front” orientation of the elements 102a, 104a, 106a to “back” and the “back” orientation of the elements 102b, 104b, 106b to “front,” and represent both configurations simultaneously, thus creating two cardioids on two output channels, one having an on-axis orientation that is 180 degrees rotated from the other.

In FIGS. 1 and 2, each of the nested groups 102, 104, 106 includes exactly two microphone elements. In other embodiments, for example, as shown in FIGS. 3 and 4, at least one of the nested groups includes two clusters of microphone spaced apart by the specified distance (e.g., dl, d2, or d3), instead of the individual microphone elements shown in FIGS. 1 and 2. In such cases, each cluster includes two or more microphone elements positioned adjacent, or in very close proximity, to each other. In embodiments, appropriate beamforming techniques may be used to sum together the audio signals captured by the microphone elements within each cluster, so that the cluster effectively operates as a single, higher sensitivity microphone with boosted SNR characteristics, as described in more detail herein.

Referring now to FIG. 3, shown is an exemplary microphone 300 comprising a plurality of microphone clusters 302a,b, 304a,b, 306a,b arranged in nested pairs 302, 304, 306, respectively, along a first axis 308 (e.g., x-axis) of the microphone 300, in accordance with embodiments. Each of the clusters 302a,b, 304a,b, 306a,b includes a plurality of microphone elements 310 arranged in close proximity to each other. The microphone elements 310 within each of the clusters 302a,b, 304a,b, 306a,b may also be arranged symmetrically about the first axis 308, as shown. The microphone elements 310 can be electrically and/or mechanically coupled to a support 311 (e.g., a frame, a PCB, a substrate, etc.) that generally defines an overall size and shape (shown here as a square) of the microphone 300. In embodiments, the microphone elements 310 can be MEMS transducers, other types of omnidirectional microphones, dynamic or condenser microphones, other types of omnidirectional transducers, etc.

While FIG. 3 shows clusters of two or four microphone elements, other numbers (including, e.g., odd numbers) of microphones elements for a given cluster are possible and contemplated. The exact number of microphone elements 310 placed in each of the clusters 302a,b, 304a,b, 306a,b may depend on, for example, space constraints, cost, performance tradeoffs, and/or the amount of signal boost desired for a given frequency band of the microphone array. As an example, clusters of four microphone elements may be preferred for lower frequency bands, which are placed on the outer edges of the microphone array where space is abundant, while clusters of two microphone elements may be preferred for higher frequency bands, which are placed towards the center of the microphone array where space is limited.

Each of the nested pairs 302, 304, 306 (also referred to herein as a “cluster-pair”) includes a first or front cluster 302a, 304a, or 306a and a duplicate or back cluster 302b, 304b, or 306b, respectively, that is identical to the corresponding first cluster 302a, 304a, or 306a in terms of the number (e.g., 2, 4, etc.) and arrangement (e.g., spacing, symmetry, etc.) of the microphone elements 310 therein. Further, within each of the cluster-pairs 302, 304, 306, the duplicate cluster 302b, 304b, or 306b can be spaced apart from the corresponding first cluster 302a, 304a, or 306a by a specified distance in order to achieve optimal microphone operation within a selected frequency band, similar to Sets 1, 2, 3 of FIG. 2. For example, in one embodiment, the clusters 302a,b, 304a,b, and 306a,b are spaced apart by the distances d1, d2, and d3, respectively, so that the first cluster-pair 302 forms a microphone array configured to cover a higher frequency band, the second cluster-pair 304 forms a microphone array configured to cover a middle frequency band, and the third cluster-pair 306 forms a microphone array configured to cover a lower frequency band.

The cluster-pairs 302, 304, 306 can be arranged in a nested configuration, similar to the nested configuration shown in FIG. 2. In the illustrated embodiment, the microphone 300 includes a first cluster-pair 302 comprising microphone clusters 302a and 302b spaced apart by a first or smallest distance, a second cluster-pair 304 comprising microphone clusters 304a and 304b spaced apart by a second or intermediate distance, and a third cluster-pair 306 comprising microphone clusters 306a and 306b spaced apart by a third or largest distance. The nested configuration can be formed by placing the microphone clusters 306a,b of the third cluster-pair 306 on the outer edges of the first axis 308, placing or nesting the microphone clusters 304a,b of the second cluster-pair 304 between the clusters 306a,b of the third cluster-pair 306, and placing or nesting the microphone clusters 302a,b of the first cluster-pair 302 between the clusters 304a,b of the second cluster-pair 304. While three cluster-pairs are shown in FIG. 3 along the first axis 308, other numbers (e.g., fewer or greater) of cluster-pairs are possible and contemplated.

In some embodiments, the microphone 300 further includes a second plurality of microphone elements 312 arranged along a second axis 314 of the microphone 300 that is orthogonal to the first axis 308. The microphone elements 312 may be organized in first, second, and third cluster-pairs 316, 318, 320 that correspond to, or are duplicates of, the first, second, and third cluster-pairs 302, 304, 306 along the first axis 308, respectively. That is, clusters 316a,b on the second axis 314 are spaced apart by the same first distance, d1, and contain the same number and arrangement of microphone elements 312, as the clusters 302a,b, respectively, on the first axis 308. Likewise, clusters 318a,b on the second axis 314 are spaced apart by the same second distance, d2, and contain the same number and arrangement of microphone elements 312, as the clusters 304a,b, respectively, on the first axis 308. And clusters 320a,b on the second axis 314 are spaced apart by the same third distance, d3, and contain the same number and arrangement of microphone elements 312, as the clusters 306a,b, respectively, on the first axis 308. In this manner, the linear nested array formed along the first axis 308 can be superimposed onto the second axis 314.

In the illustrated embodiment, a center of the first axis 308 is aligned with a center of the second axis 314, and each of the cluster-pairs 302, 304, 306, 316, 318, 320 is symmetrically placed on, or centered about, the axis that is orthogonal to it (e.g., axis 314 or 308). This ensures that the linear microphone array formed by the microphone elements 310 on the first axis 308 shares a center or midpoint with the linear microphone array formed by the microphone elements 312 on the second axis 314. In embodiments, appropriate beamforming techniques can be applied to the orthogonal linear arrays of the microphone 300 to create a toroidal pickup pattern and/or to form a first order polar-pattern (such as, e.g., super cardioid, hypercardioid, etc.) and steer that polar pattern to a desired angle to obtain planar directionality. For example, while the microphone elements 310 along the first axis 308 can be used to create a linear array with a directional polar pattern, such as, e.g., a cardioid pickup pattern, the combination of two orthogonal linear arrays along the axes 308 and 314 may form a toroidal pickup pattern or a planar directional polar pattern. In some embodiments, appropriate beamforming techniques can form a unidirectional or cardioid polar pattern pointed toward the end of each axis, or a total of four polar patterns pointing in four different planar directions, to maximize pickup all around the microphone 300. In other embodiments, additional polar patterns may be created by combining the original four polar patterns and steering the combined pattern to any angle along the plane of, for example, the table on which the microphone 100 rests.

In some embodiments, the microphone 300 further includes additional microphone elements 322 placed along one or more optional axes of the microphone 300, such as, e.g., diagonal axes 324 and 326 shown in FIG. 3, to boost SNR or increase microphone sensitivity or directivity within a given frequency band. The additional microphone elements 322 may be arranged as single elements (not shown) or in clusters, as shown in FIG. 3.

Referring now to FIG. 4, shown is another exemplary microphone 400 comprising a first linear microphone array 402 arranged along a first axis 404 and a second linear microphone array 406 arranged along a second axis 408 that is orthogonal to the first axis 404, in accordance with embodiments. Like the microphone 300 shown in FIG. 3, the orthogonal linear arrays 402 and 406 can be used to create a planar directional polar pattern for the microphone 400. Also like the microphone 300, the linear microphone array 402 includes three nested cluster-pairs 410, 412, and 414 on the first axis 404, the linear microphone array 406 includes three corresponding nested cluster-pairs 416, 418, and 420 on the second axis 408, and all of the microphone elements included therein are positioned on a first side or surface 422 of a support 423 (e.g., a frame, a PCB, a substrate, etc.) included in the microphone 400. The microphone elements can be electrically and/or mechanically coupled to the support 423, which generally defines an overall size and shape (shown here as a circle) of the microphone 400. In FIG. 4, each of the cluster-pairs 410, 412, 414, 416, 418, 420 includes clusters of four microphone elements (or “quads”). Other numbers of microphone elements per cluster are possible and contemplated.

In embodiments, the microphone 400 can further include a plurality of microphone elements positioned on a second side or surface (not shown) of the support 423, opposite the first surface 422, to increase the number of distinct frequency bands covered by the microphone 400. In the illustrated embodiment, the linear microphone array 402 includes a fourth cluster-pair 424 positioned on the second surface of the support 423, opposite the cluster-pairs 410, 412, and 414. As an example, the second surface may be a top or front surface of the microphone 400, while the first surface 422 is the back or bottom surface of the microphone 400, or vice versa. As shown, the fourth cluster-pair 424 includes clusters 424a and 424b, each of which includes a pair of microphone elements, spaced apart by a fourth distance that is smaller than a first distance between clusters 410a,b of the first cluster-pair 410. For example, in one embodiment, the fourth distance between clusters 424a,b is 7 mm, while the first distance between clusters 410a,b is 15.9 mm, a second distance between clusters 412a,b is 40 mm, and a third distance between clusters 414a,b is 88.9 mm. As such, the fourth cluster-pair 424 is nested within the first cluster-pair 410, but along an opposite side of the first axis 404. Similarly, the linear microphone array 406 can further include a fourth cluster-pair 426 comprising clusters 426a,b, each of which includes a pair of microphone elements. The clusters 426a,b are also spaced apart from each other by the fourth distance and are nested within a first cluster-pair 416 but along the opposite side of the second axis 408. While two cluster-pairs comprising eight microphone elements in total are shown as being arranged on the second surface of the microphone 400, more or fewer cluster-pairs and/or microphone elements are possible and contemplated.

The fourth distance may be selected to provide coverage of a higher frequency band than, for example, the high frequency band covered by the first cluster-pairs 410 and 416. For example, in certain embodiments, it may not be possible to place the fourth cluster-pairs 424 and 426 on the same surface 422 as the other cluster-pairs 410, 412, 414 due to a lack of remaining space there between. Placement of microphone elements on the opposite surface of the support 423 increases the amount of usable surface area, which enables coverage of additional frequency bands, including higher bands. For example, the microphone 400 may have broader overall frequency band coverage than, for example, the microphone 300. While coverage of four frequency bands is described herein, additional frequency bands may be added, through placement of additional sets of microphone elements appropriately spaced apart along each axis, until all desired bandwidths and/or the entire audible spectrum are covered within the requisite SNR target.

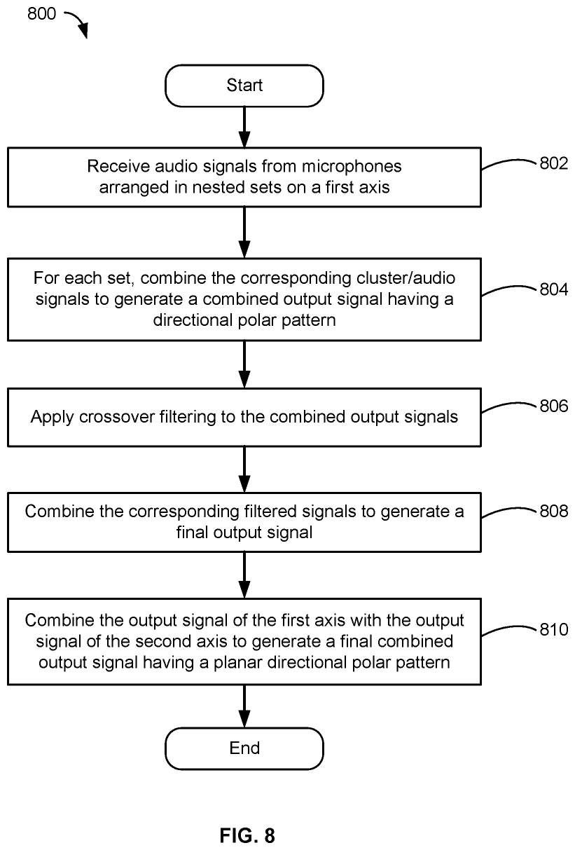

FIG. 5 illustrates an exemplary microphone system 500 in accordance with embodiments. The microphone system 500 comprises a plurality of microphone elements 502, a beamformer 504, and an output generation unit 506. Various components of the microphone system 500 may be implemented using software executable by one or more computers, such as a computing device with a processor and memory, and/or by hardware (e.g., discrete logic circuits, application specific integrated circuits (ASIC), programmable gate arrays (PGA), field programmable gate arrays (FPGA), etc.). For example, some or all components of the beamformer 504 may be implemented using discrete circuitry devices and/or using one or more processors (e.g., audio processor and/or digital signal processor) (not shown) executing program code stored in a memory (not shown), the program code being configured to carry out one or more processes or operations described herein, such as, for example, method 800 shown in FIG. 8. Thus, in embodiments, the system 500 may include one or more processors, memory devices, computing devices, and/or other hardware components not shown in FIG. 5. In a preferred embodiment, the system 500 includes at least two separate processors, one for consolidating and formatting all of the microphone elements and another for implementing DSP functionality.

The microphone elements 502 may include the microphone elements included in any of the microphone 100 shown in FIG. 1, the microphone 300 shown in FIG. 3, the microphone 400 shown in FIG. 4, or other microphone designed in accordance with the techniques described herein. The beamformer 504 may be in communication with the microphone elements 502 and may be used to beamform audio signals captured by the microphone elements 502. The output generation unit 506 may be in communication with the beamformer 504 and may be used to process the output signals received from the beamformer 504 for output generation via, for example, loudspeaker, telecast, etc.

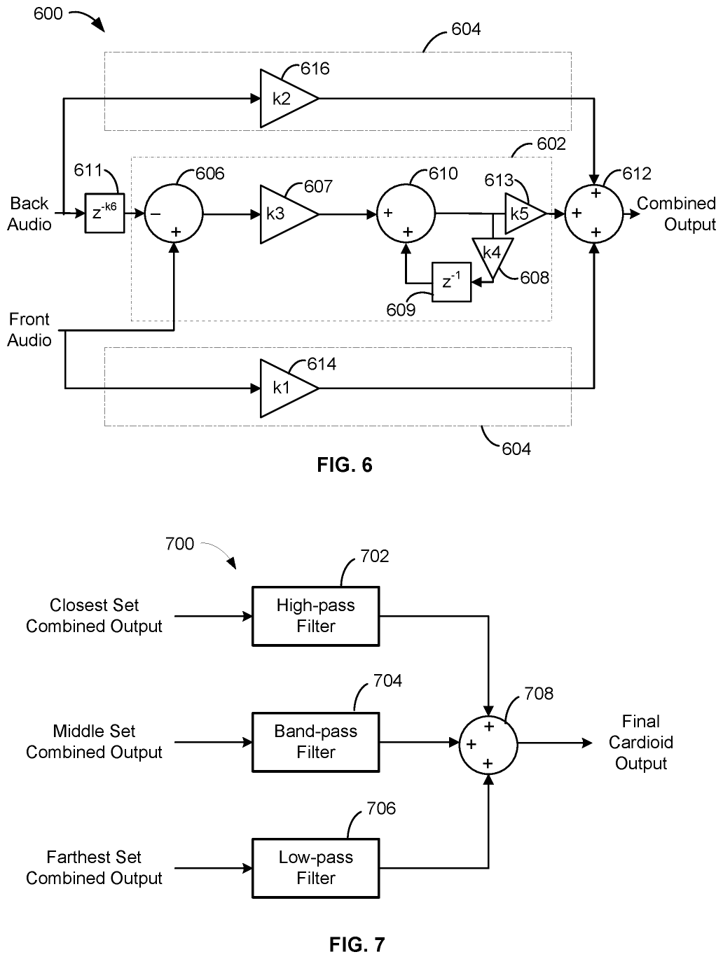

In embodiments, the beamformer 504 may include one or more components to facilitate processing of the audio signals received from the microphone elements 502, such as, e.g., pattern-forming beamformer 600 of FIG. 6 and/or pattern-combining beamformer 700 of FIG. 7. As described in more detail below with reference to FIG. 8, pattern-forming beamformer 600 combines audio signals captured by a set of microphone elements arranged in a linear array to form a combined output signal having a directional polar pattern, in accordance with embodiments. And pattern-combining beamformer 700 combines the output signals received from multiple nested sets in a microphone array to form a final cardioid output for the overall array, in accordance with embodiments. Other beamforming techniques may also be performed by the beamformer 504 to obtain a desired output.

FIG. 8 illustrates an exemplary method 800 of generating a beamformed output signal with a directional polar pattern for a microphone array comprising at least one linear nested array, in accordance with embodiments. All or portions of the method 800 may be performed by one or more processors (such as, e.g., an audio processor included in the microphone system 500 of FIG. 5) and/or other processing devices (e.g., analog to digital converters, encryption chips, etc.) within or external to the microphone. In addition, one or more other types of components (e.g., memory, input and/or output devices, transmitters, receivers, buffers, drivers, discrete components, logic circuits, etc.) may also be utilized in conjunction with the processors and/or other processing components to perform any, some, or all of the steps of the method 800. For example, program code stored in a memory of the system 500 may be executed by the audio processor in order to carry out one or more operations of the method 800.

In some embodiments, certain operations of the method 800 may be performed by the pattern-forming beamformer 600 of FIG. 6, and other operations of the method 800 may be performed by the pattern-combining beamformer 700 of FIG. 7. The microphone array may be any of the microphone arrays described herein, such as, e.g., the microphone array 200 of FIG. 2, one or more of the linear microphone arrays in the microphone 300 of FIG. 3, or one or more of the linear microphone arrays 402 and 406 shown in FIG. 4. In some embodiments, the microphone array includes a plurality of microphone elements coupled to a support, such as, e.g., the support 112 of FIG. 1, the support 311 of FIG. 3, or the support 423 of FIG. 4. The microphone elements may be, for example, MEMS transducers which are inherently omnidirectional, other types of omnidirectional microphones, electret or condenser microphones, or other types of omnidirectional transducers or sensors.

Referring back to FIG. 8, the method 800 begins, at block 802, with a beamformer or processor, receiving audio signals from a plurality of microphone elements (e.g., microphone elements 502 of FIG. 5) arranged in a nested configuration along one or more axes of a microphone support. The nested configuration may take different forms, for example, as shown by the different microphone arrays of FIGS. 1-4. As an example, the plurality of microphone elements can include a first set of microphone elements arranged along the first axis (e.g., axis 308 of FIG. 3) and nested within a second set of microphone elements also on the same axis. The first set (e.g., Set 1 of FIG. 2) may include at least two microphone elements (e.g., microphone elements 102a,b of FIG. 2) spaced apart from each other by a first distance (e.g., d1 of FIG. 2) selected for optimal microphone operation in a first frequency band. The second set (e.g., Set 2 of FIG. 2) may include at least two microphone elements (e.g., microphone elements 104a,b of FIG. 2) spaced apart from each other by a second distance (e.g., d2 of FIG. 2) that is greater than the first distance and is selected for optimal microphone operation in a second frequency band lower than the first frequency band. The microphone elements of each set may be symmetrically positioned on the first axis, for example, relative to a second, orthogonal axis (e.g., as shown in FIG. 1).

In some embodiments, the plurality of microphone elements may further include a third set (e.g., Set 3 of FIG. 2) of elements comprising at least two microphone elements (e.g., microphone elements 106a,b of FIG. 2) spaced apart from each other by a third distance (e.g., d3 of FIG. 2) along the first axis. The third distance may be larger than the second distance, so that the second set can be nested within the third set. The third distance may be selected to configure the third set of microphone elements for optimal microphone operation in a third frequency band that is lower than the second frequency band.

In some embodiments, at least one of the nested sets is comprised of two clusters of microphone elements spaced apart by the specified distance along the first axis (e.g., as shown in FIG. 3), instead of two individual microphone elements. For such sets, the at least two microphone elements may include a first cluster of two or more microphone elements (e.g., cluster 302a, 304a, or 306a of FIG. 3) and a second cluster of two or more microphone elements (e.g., cluster 302b, 304b, or 306b of FIG. 3) located a specified distance (e.g., d1, d2, or d3) from the first cluster. The second cluster for each set may correspond with, or be a duplicate of, the first cluster of that set in terms of number (e.g., 2, 4, etc.) and arrangement (e.g., placement, spacing, symmetry, etc.) of microphone elements.

At block 804, for each set of microphone elements along a given axis, the audio signals received from the microphone elements of that set are combined to generate an output signal having a directional polar pattern, such as, e.g., a cardioid polar pattern. In certain embodiments, combining the audio signals for a given set of microphone elements at block 804 includes subtracting the audio signals received from the microphone elements therein to generate a first signal having a bidirectional polar pattern, summing the received audio signals to generate a second signal having an omnidirectional polar pattern, and summing the first and second signals to generate a combined output signal having a cardioid polar pattern. As will be appreciated, the operations associated with block 804 may be repeated until all sets within the microphone array have corresponding output signals representing the combined outputs of the microphone elements therein.

If the microphone elements are arranged in clusters, the signal combining process at block 804 may include, prior to generating the first signal, creating a cluster signal for each cluster in the set (e.g., front cluster and back cluster) based on the audio signals captured by the microphone elements in that cluster. The cluster signal may be created by, for example, summing the audio signals received from each of the closely-located microphone elements included in that cluster and normalizing the summed result. Each cluster of microphone elements may effectively operate as a single, higher sensitivity microphone that provides a boost in SNR (as compared to the individual microphone elements). Once front and back cluster signals are created for each cluster within the set (or cluster-pair), the front and back cluster signals for each set may be combined in accordance with block 804 to generate the combined output signal for that set. Other techniques for combining the audio signals for each microphone cluster are also possible and contemplated.

In embodiments, all or portions of the signal combining process in block 804 may be performed by the exemplary pattern-forming beamformer 600 of FIG. 6. As shown, the beamformer 600 receives audio signals produced or output by one or more front microphone elements (e.g., a single element or a front cluster of elements) and one or more back microphone elements (e.g., a single element or a back cluster of elements) included in a set (or cluster-pair) of a microphone array. The front and back elements may be spaced apart from each other by a specified distance along a first axis. In a preferred embodiment, the microphone elements are MEMS transducers that inherently have an omnidirectional polar pattern. If the microphone array includes spaced apart clusters of microphone elements, the received audio signals may be the corresponding front and back cluster signals for the given cluster-pair.

As shown in FIG. 6, the front and back audio signals are provided to two different segments of the beamformer 600. A first segment 602 generates a first output signal having a bidirectional, or other first order polar pattern by, among other things, taking a differential of the audio signals received from the omnidirectional microphone elements of the given cluster-pair. A second segment 604 generates a second output signal having an omnidirectional polar pattern, at least within the frequencies of interest, by, among other things, summing the audio signals received from the omnidirectional microphone elements. The outputs of the first segment 602 and the second segment 604 are summed together to generate a combined output signal with a cardioid pickup pattern, or other directional polar pattern.

In embodiments, the first segment 602 can perform subtraction, integration, and delay operations on the received audio signals to create the bidirectional or other first order polar pattern. As shown in FIG. 6, the first segment 602 includes a subtraction (or invert-and-sum) element 606 that is in communication with the front and back microphone elements. The subtraction element 606 generates a differential signal by subtracting the back audio signal from the front audio signal.

The first segment 602 also includes an integration subsystem for performing an integration operation on the differential signal received from the subtraction element 606. In some embodiments, the integration subsystem can operate as a correction filter that corrects for the sloped frequency response of the differential signal output by the subtraction element 606. For example, the correction filter may have a sloped frequency response that is the inverse of the differential signal's sloped response. Additionally, the correction filter may add a 90 degree phase shift to the output of the first segment 602, so that the front of the pattern is phase-aligned and the back of the pattern is anti-aligned, thus enabling creation of the cardioid pattern. In some embodiments, the integration subsystem may be implemented using appropriately configured low-pass filters.

In the illustrated embodiment, the integration subsystem includes an integration gain element 607 configured to apply a gain factor k3 (also known as an integration constant) to the differential signal. The integration constant k3 may be tuned to the known separation or distance (e.g., d1, d2, or d3) between the microphone clusters (or elements). For example, the integration constant k3 may be equal to (speed of sound)/(sample rate)/(distance between clusters). The integration subsystem also includes a feedback loop formed by a feedback gain element 608, a delay element 609, and a summation element 610, as shown. The feedback gain element 608 has a gain factor k4 that may be selected to configure the feedback gain element 608 as a “leaky” integrator, so as to make the first segment 602 more robust against feedback instabilities, as needed. As an example, in some embodiments, the gain factor k4 may be equal to or less than one (1). The delay element 609 adds an appropriate amount of delay (e.g., z⁻¹) to the output of the feedback gain element 608. In the illustrated embodiment, the delay amount is set to one (i.e. a single sample delay).

In some embodiments, the first segment 602 also includes a second delay element 611 at the beginning of the first segment 602, as shown in FIG. 6, in order to add a delay (e.g., z^{-k6}) to the back audio signal before subtraction by element 606. The “k6” parameter of the second delay element 611 may be selected based on a desired first order polar pattern for the path 602. For example, when k6 is set to zero (0), the first segment 602 creates a bidirectional polar pattern, However, when k6 is set to an integer greater than zero, other first order polar patterns may be created.

As shown in FIG. 6, the output of the summation element 610 (or the output of the integration subsystem) may be provided to a final summation element 612 that also receives the outputs of the second segment 604. In some embodiments, the first segment 602 further includes a gain element 613, with gain factor k5, coupled between the output of the integration subsystem and an input for the final summation element 612. The gain element 613 may be configured to apply an appropriate amount of gain to the corrected output of the integration subsystem, before reaching the summation element 612. The exact amount of gain k5 may be selected based on gain amounts applied in the second segment 604, as described below.

The second segment 604 can perform summation and gain operations on the audio signals received from the given set of microphone elements to create the omnidirectional response. As shown in FIG. 6, the second segment 604 includes a first gain element 614, with gain factor k1, in communication with the front microphone element(s) and a second gain element 616, with gain factor k2, in communication with the back microphone element(s). In some embodiments, the gain elements 614 and 616 can be configured to normalize the output of the front and back microphone elements. For example, the gain factors k1 and k2 for the gain elements 614 and 616 may be set to 0.5 (or ½), so that the output of the second segment 604 matches the output of a single omnidirectional microphone in terms of magnitude. Other gain amounts are possible and contemplated.

In some embodiments, the gain component 613 may be included on the first segment 602 as an alternative to the first and second gain elements 614, 616 of the second segment 604. In other embodiments, all three gain components 613, 614, 616 may be included, and the gain factors k1, k2, k5 may be configured in order to add an appropriate amount of gain to the corrected output of the integration subsystem and/or the output of the second segment 604, before they reach the summation element 612. For example, the amount of gain k5 may be selected in order to obtain a specific first order polar pattern. In a preferred embodiment, to create a cardioid pattern, the gain factor k5 may be set to one (1), so that the output of the first segment 602 (e.g., the bidirectional component) matches the output of the second segment 604 (e.g., the omnidirectional component) in terms of magnitude. Other values for the gain factor k5 may be selected depending on the desired polar pattern for the first segment path 602, the value selected for the k6 parameter of the initial delay element 611, and/or the desired polar pattern for the overall set of microphone elements.

As shown in FIG. 6, the outputs of the gain elements 614 and 616 can be provided to the final summation element 612, which sums the outputs to generate the omnidirectional output of the second segment 604. The final summation element 612 also sums the output of the second segment 604 with the bidirectional (or other first order pattern) output of the first segment 602, thus generating the cardioid (or other first order pattern) output of the beamformer 600.

Referring back to FIG. 8, once a final output signal having a directional polar pattern is obtained at block 804, the method 800 continues to block 806, where crossover filtering is applied to the combined output signal generated for each set of microphone elements arranged along a given axis, so that each set can optimally cover the frequency band associated therewith. At block 808, the filtered outputs for each set of microphone elements may be combined to generate a final output signal for the microphone elements on that axis.

In embodiments, the crossover filtering includes applying an appropriate filter to the output of each set (or cluster-pair) in order to isolate the combined output signals into different or discrete frequency bands. As will be appreciated, there is an inverse relationship between the amount of separation between elements (or clusters) in a given set (or cluster-pair) and the frequency band(s) that can be optimally covered by that set. For example, larger microphone spacings may have a smaller low frequency response loss, thus resulting in a better low frequency SNR. At the same time, larger spacings can have a lower frequency null, and smaller spacings can have a higher frequency null. In embodiments, crossover filtering can be applied to avoid these nulls and stitch together an ideal frequency response for the microphone array, while maintaining an SNR that is better than a single, closely-spaced pair of microphones.

According to embodiments, all or portions of blocks 806 and 808 may be performed by exemplary pattern-combining beamformer 700 of FIG. 7. In the illustrated embodiment, the beamformer 700 receives combined output signals for a nearest, or most closely-spaced, set of microphone elements (e.g., clusters 302a,b of FIG. 3), an intermediate, or medium-spaced, set of microphone elements (e.g., clusters 304a,b of FIG. 3), and a furthest, or farthest-spaced, set of microphone elements (e.g., clusters 306a,b of FIG. 3), all along a first axis. In embodiments, the beamformer 700 may be in communication with a plurality of beamformers 600 in order to receive the combined output signals. For example, a separate beamformer 600 may be coupled to each cluster-pair (or set) included in the microphone array, so that the respective beamformer 600 can be tailored to, for example, the separation distance of that cluster-pair and/or other factors.

As shown, the beamformer 700 includes a plurality of filters 702, 704, 706 to implement the crossover filtering process. In the illustrated example, the combined output signal for the closest set is provided to high-pass filter 702, the combined output signal for the middle set is provided to bandpass filter 704, and the combined output signal for the farthest set is provided to low-pass filter 706. The cutoff frequencies for filters 702, 704, and 706 may be selected based on the specific frequency response characteristics of the corresponding set or cluster-pair, including, for example, location of frequency nulls, a desired frequency response for the microphone array, etc. According to one embodiment, for the bandpass filter 704, the high frequency cutoff may be determined by the natural −1 decibel (dB) point of the cardioid frequency response for the corresponding combined output signal, and the low frequency cutoff may be determined by the cutoff of the lower band, but no lower than 20 hertz (Hz). The filters 702, 704, 706 may be analog or digital filters. In a preferred embodiment, the filters 702, 704, 706 are implemented using digital finite impulse response (FIR) filters on a digital signal processor (DSP) or the like.

In other embodiments, the beamformer 700 may include more or fewer filters. For example, the beamformer 700 could be configured to include four filters or two filters, instead of the illustrated three band solution. In still other embodiments, the beamformer 700 may include a different combination of filters. For example, the beamformer 700 may be configured to include multiple bandpass filters, instead of high-pass or low-pass filters, or any other combination of bandpass, low-pass, and/or high-pass filters.

As shown in FIG. 7, the filtered outputs are provided to a summation element 708 of the beamformer 700. The summation element 708 combines or sums the filtered outputs to generate an output signal, which may represent a final cardioid output for the microphone elements included on the first axis of the microphone array, or other first order polar pattern.

In some embodiments, the plurality of microphone elements for a given microphone array further includes additional sets of elements arranged along a second axis (e.g., axis 314 of FIG. 3) that is orthogonal to the first axis. The additional sets on the second axis may be duplicates or copies of the sets arranged on the first axis in terms of arrangement (e.g., nesting, spacing, clustering, etc.) and number of microphone elements (e.g., 1, 2, 4, etc.) For example, the additional sets of microphone elements may include a first set (e.g., cluster-pair 316 of FIG. 3) nested within a second set (e.g., cluster-pair 318 of FIG. 3) along the second axis. Like the first set arranged along the first axis, the first set on the second axis may include at least two microphone elements (e.g., clusters 316a,b of FIG. 3) spaced apart from each other by the first distance (e.g., d1 of FIG. 2), so as to optimally cover the first frequency band. Likewise, the second set may include at least two microphone elements (e.g., clusters 318a,b of FIG. 3) spaced apart from each other by the second distance (e.g., d2 of FIG. 2), so as to optimally cover the second frequency band, similar to the second set on the first axis.

Referring back to FIG. 8, in cases where the microphone array includes microphone elements on two orthogonal axes, the method 800 may further include, at block 810, combining the final output signal generated for the first axis with a final output signal generated for the second axis in order to create a final combined output signal having a planar and/or steerable directional polar pattern. In such cases, blocks 802 to 808 may be applied to the microphone elements arranged on the second axis to generate the final output signal for that axis.

For example, at block 802, audio signals may also be received from each microphone element on the second axis, in addition to the first axis. At block 804, a combined output signal may be generated for each set (or cluster-pair) of microphone elements arranged on the second axis, in addition to the first axis. That is, the combining process in block 804 (and as shown in FIG. 6) may be repeated for each set of elements on each axis of the array. The filter and combine processes in blocks 806 and 808 (and as shown in FIG. 7) may be performed in an axis-by-axis manner. That is, the combined output signals for the sets included on the second axis may be filtered and combined together in one beamforming process, while the combined output signals for the sets included on the second axis may be filtered and combined together in another beamforming process, either simultaneously or consecutively. The final output signals generated for each axis at block 808 can then be provided to block 810.

At block 810, the final output signal for the first axis is combined with the final output signal for the second axis to obtain a final combined output signal with a planar directional response (e.g., toroidal, unidirectional, etc.). The signals for the two axes can be combined using weighting and summing techniques, if a steered first order polar pattern is desired, or using filtering and summing techniques, if a toroidal polar pattern is desired. For example, appropriate weighting values can be applied to the output signals for each axis to create different polar patterns and/or steer the lobes of the pickup pattern to a desired direction.

In accordance with certain embodiments, a method of assembling a microphone array can comprise forming a first set of microphone elements along a first axis, the first set including at least two microphone elements spaced apart from each other by a first distance; forming a second set of microphone elements along the first axis, the second set including at least two microphone elements spaced apart from each other by a second distance greater than the first distance, such that the first set is nested within the second set; and electrically coupling each microphone element to at least one processor for processing audio signals captured by the microphone elements, wherein the first distance is selected for optimal microphone operation in a first frequency band, and the second distance is selected for optimal microphone operation in a second frequency band that is lower than the first frequency band. According to aspects, the method can further comprise forming a third set of elements positioned along a second axis orthogonal to the first axis, the third set comprising at least two microphone elements spaced apart from each other by the second distance; and forming a fourth set of elements nested within the third set along the second axis, the fourth set comprising at least two microphone elements spaced apart from each other by the first distance. According to further aspects, the method can also comprise forming a fifth set of elements comprising at least two microphone elements spaced apart from each other by a third distance along the first axis, the third distance being greater than the second distance, so that the second set is nested within the fifth set, wherein the third distance is selected for optimal microphone operation in a third frequency band that is lower than the second frequency band. According to other aspects, the method can further comprise placing a select one of the first and second sets on a first surface of the microphone array, and placing the remaining set on a second surface opposite the first surface.

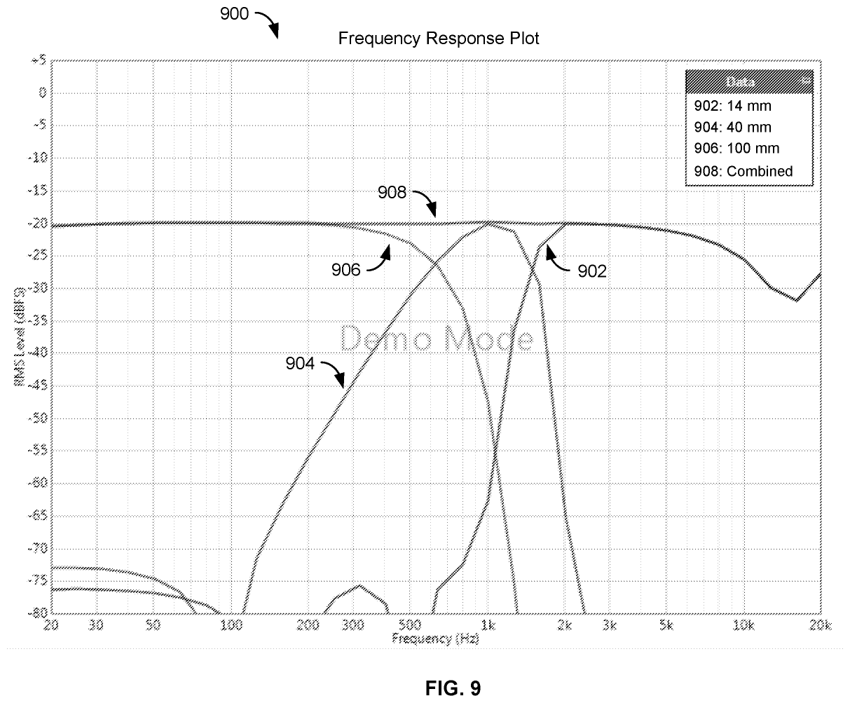

FIG. 9 is a frequency response plot 900 for an exemplary microphone array with three sets of microphone elements arranged in a linear nested array, for example, similar to the cluster-pairs 302, 304, 306 arranged along the first axis 308 in FIG. 3, in accordance with embodiments. In particular, the plot 900 shows filtered frequency responses for a closest set (902) including microphone clusters spaced 14 millimeters (mm) apart, a middle set (904) including microphone clusters spaced 40 mm apart, and a farthest set (906) including microphone clusters spaced 100 mm apart. In addition, plot 900 shows a combined frequency response 908 for all three sets of the linear nested array. In embodiments, the frequency responses 902, 904, 906 represent the filtered outputs of respective crossover filters 702, 704, 706 included in the pattern-combining beamformer 700 of FIG. 7, and the frequency response 908 is the combined output, or summation, of the filtered signals.

As shown, the frequency response 902 of the closest set flattens out after about 2 kilohertz (kHz), while the frequency response 906 of the farthest set is generally flat until about 200 Hz. The frequency response 904 of the middle set peaks at about 1 kHz, with a −6 dB/octave rise crossing the farthest set response 906 at about 650 Hz and a −6 dB/octave drop crossing the closest set response 902 at about 1.5 kHz. The filtered and combined frequency response 908 stitches the three responses together to provide a generally flat frequency response across almost the entire audio bandwidth (e.g., 20 Hz to 20 kHz), with attenuation only occurring at higher frequencies (e.g., above 5 kHz).

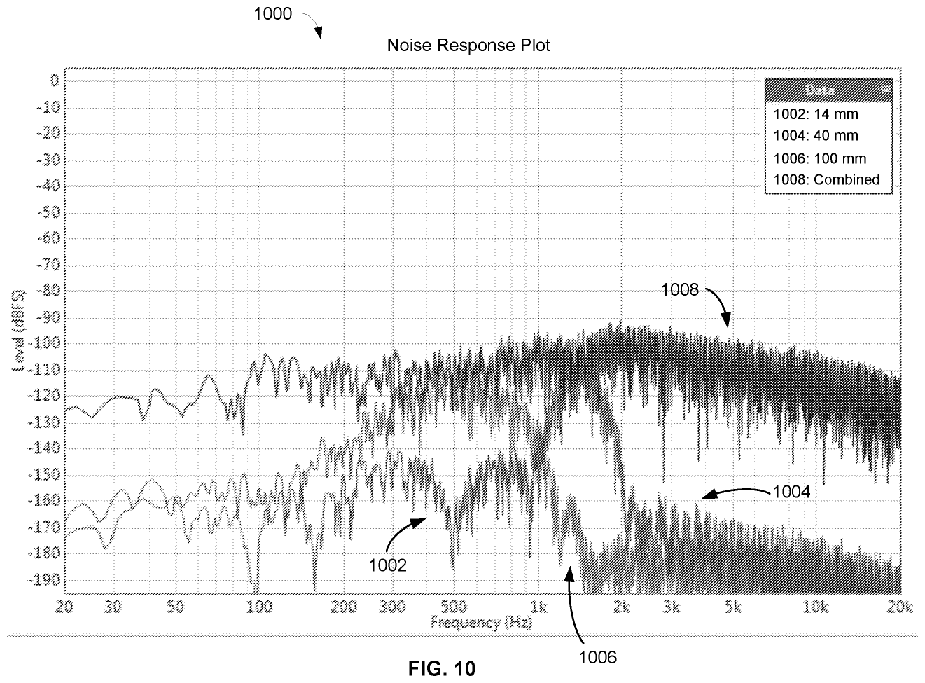

FIG. 10 illustrates a noise response plot 1000 for an exemplary microphone array with three sets of microphone elements arranged in a linear nested array, for example, similar to the cluster-pairs 302, 304, 306 arranged along the first axis 308 in FIG. 3, in accordance with embodiments. The noise response plot 1000 corresponds to the filtered and combined frequency response plot 900 shown in FIG. 9. In particular, the noise response plot 1000 shows noise responses that represent the filtered outputs of the closest set (1002), the middle set (1004), and the farthest set (1006), as well as the combined output of all three (1008).

Thus, the techniques described herein provide a high performance microphone capable of having a highly directional polar pattern, improved signal-to-noise ratio (SNR), and wideband audio application (e.g., 20 hertz (Hz)≤f≤20 kilohertz (kHz). The microphone includes at least one linear nested array comprising one or more sets of microphone elements separated by a distance selected to optimally cover a desired operating band. In some cases, the microphone elements are clustered and crossover filtered to further improve SNR characteristics and optimize the frequency response. One or more beamformers can be used to generate a combined output signal for each linear array having a desired directional polar pattern (e.g., cardioid, hypercardioid, etc.). In some cases, at least two linear arrays are symmetrically arranged on orthogonal axes to achieve a planar directional polar pattern (e.g., toroidal, etc.), thus making the microphone optimal for conferencing applications.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

What is claimed is:

1. A microphone array, comprising:
a plurality of microphone elements comprising:
a first set of elements arranged along a first axis and comprising at least two microphone elements spaced apart from each other by a first distance;
a second set of elements arranged along the first axis and comprising at least two microphone elements spaced apart from each other by a second distance greater than the first distance, such that the first set is nested within the second set;
a third set of elements arranged along a second axis orthogonal to the first axis, the third set comprising at least two microphone elements spaced apart from each other by the second distance; and
a fourth set of elements nested within the third set along the second axis, the fourth set comprising at least two microphone elements spaced apart from each other by the first distance,
wherein the first distance is selected for optimal microphone operation in a first frequency band, and the second distance is selected for optimal microphone operation in a second frequency band that is lower than the first frequency band, and
wherein for each set, the at least two microphone elements includes a first cluster of two or more microphone elements and a second cluster of two or more microphone elements, the first cluster being spaced apart from the second cluster by the specified distance.

2. The microphone array of claim 1, wherein within each cluster, the microphone elements are arranged adjacent to each other and symmetrically about said first axis.

3. The microphone array of claim 2, wherein each cluster included in the first set contains two microphone elements, and each cluster included in the second set contains four microphone elements.

4. The microphone array of claim 1, wherein for each set of elements, the second cluster corresponds with the first cluster in terms of number and arrangement of microphone elements.

5. The microphone array of claim 1, wherein a center of the first axis is aligned with a center of the second axis, and each set of microphone elements is symmetrically arranged relative to the orthogonal axis.

6. The microphone array of claim 1, wherein the third and fourth sets of elements correspond to the first and second sets of elements, respectively, in terms of number and arrangement of microphone elements.

7. The microphone array of claim 1, wherein the plurality of microphone elements further comprises:
a fifth set of elements comprising at least two microphone elements spaced apart from each other by a third distance along the first axis, the third distance being greater than the second distance, so that the second set is nested within the fifth set, wherein the third distance is selected for optimal microphone operation in a third frequency band that is lower than the second frequency band.

8. The microphone array of claim 1, wherein a select one of the first and second sets is placed on a first surface of the microphone array, and the remaining set is placed on a second surface opposite the first surface.

9. The microphone array of claim 8, wherein the first surface is a back face of the microphone array and the second surface is a front face thereof.

10. The microphone array of claim 1, wherein each microphone element is a micro-electrical mechanical system (MEMS) microphone.

11. A microphone system, comprising:
a microphone array including a plurality of microphone elements coupled to a support, the plurality of microphone elements comprising first and second sets of elements arranged along a first axis of the support, the first set being nested within the second set, wherein the first set includes at least two microphone elements spaced apart from each other by a first distance selected to configure the first set for optimal microphone operation in a first frequency band, and the second set includes at least two microphone elements spaced apart from each other by a second distance that is greater than the first distance, the second distance being selected to configure the second set for optimal microphone operation in a second frequency band that is lower than the first frequency band;
a memory configured to store program code for processing audio signals captured by the plurality of microphone elements and generating an output signal based thereon;
at least one processor in communication with the memory and the microphone array, the at least one processor configured to execute the program code in response to receiving audio signals from the microphone array,
wherein the program code is configured to:
receive audio signals from each microphone element of the microphone array;
for each set of elements along the first axis, combine the audio signals for the microphones in the set to generate a combined output signal with a directional polar pattern; and
combine the combined output signals for the first and second sets to generate a final output signal for all of the microphone elements on the first axis.

12. The microphone system of claim 11, wherein combine the audio signals for each set of elements comprises:
subtract the audio signals to generate a first signal;
sum the audio signals to generate a second signal; and
sum the first and second signals to generate the combined output signal.

13. The microphone system of claim 11, wherein for each set, the at least two microphone elements includes a first cluster of two or more microphone elements and a second cluster of two or more microphone elements, the first cluster being spaced apart from the second cluster by the specified distance,
and wherein combine the audio signals for each set of elements comprises:
for each cluster in a given set, sum the audio signals received from the microphone elements in the cluster to generate a cluster signal, and
for each set, combine the cluster signals for that the set to generate the combined output signal.

14. The microphone system of claim 13, wherein for each set of elements, the second cluster corresponds with the first cluster in terms of number and arrangement of microphone elements.

15. The microphone system of claim 11, wherein the plurality of microphone elements further comprises third and fourth sets of elements arranged along a second axis of the support orthogonal to the first axis, the third set being nested within the fourth set, and the third and fourth sets corresponding to the first and second sets, respectively, in terms of number and arrangement of microphone elements, and wherein the program code is further configured to:
for each set of elements along the second axis, combine the audio signals for the microphone elements in the set to create a combined output signal with a directional polar pattern;
combine the combined output signals for the third and fourth sets to generate a final output signal for the microphone elements on the second axis; and
combine the final output signal of the first axis with the final output signal of the second axis to produce a final combined output signal with a planar directional polar pattern.

16. The microphone system of claim 11, wherein the program code is further configured to:
prior to generating the output signal, apply crossover filtering to the combined output signals so that each set of elements on the first axis optimally covers the frequency band associated therewith.

17. The microphone system of claim 16, wherein the plurality of microphone elements further comprises a fifth set of elements comprising at least two microphone elements spaced apart from each other by a third distance along the first axis, the third distance being larger than the second distance, so that the second set is nested within the fifth set, wherein the third distance is selected to configure the fifth set for optimal microphone operation in a third frequency band that is lower than the second frequency band, and
wherein apply crossover filtering includes apply a bandpass filter to the combined output signal of the second set, apply a low pass filter to the combined output signal of the fifth set, and apply a high pass filter to the combined output signal of the first set.

18. The microphone system of claim 11, wherein each microphone element is a micro-electrical mechanical system (MEMS) microphone.

19. A method performed by one or more processors to generate an output signal for a microphone array comprising a plurality of microphone elements coupled to a support, the method comprising:
receiving audio signals from the plurality of microphone elements, the plurality of microphone elements comprising first and second sets of elements arranged along a first axis of the support, the first set being nested within the second set, wherein the first set includes at least two microphone elements spaced apart from each other by a first distance selected to configure the first set for optimal microphone operation in a first frequency band, and the second set includes at least two microphone elements spaced apart from each other by a second distance that is greater than the first distance, the second distance being selected to configure the second set for optimal microphone operation in a second frequency band that is lower than the first frequency band;
for each set of elements along the first axis, combining the audio signals for the microphone elements in the set to generate a combined output signal with a directional polar pattern; and
combining the combined output signals for the first and second sets to generate a final output signal for all microphone elements on the first axis.

20. The method of claim 19, wherein combining the audio signals for each set of elements comprises:
subtracting the audio signals to generate a first signal;
summing the audio signals to generate a second signal; and
summing the first and second signals to generate the combined output signal.

21. The method of claim 19, wherein for each set, the at least two microphone elements includes a first cluster of two or more microphone elements and a second cluster of two or more microphone elements, the first cluster being spaced apart from the second cluster by the specified distance,
and wherein combining the audio signals for each set of elements comprises:
for each cluster in a given set, summing the audio signals received from the microphone elements in the cluster to generate a cluster signal, and
for each set, combining the cluster signals for that set to generate the combined output signal.

22. The method of claim 21, wherein for each set of elements, the second cluster corresponds with the first cluster in terms of number and arrangement of microphone elements.

23. The method of claim 19, wherein the plurality of microphone elements further comprises third and fourth sets of elements arranged along a second axis of the support orthogonal to the first axis, the third set being nested within the fourth set, wherein the third and fourth sets correspond to the first and second sets, respectively, in terms of number and arrangement of microphone elements, and wherein the method further comprises:
for each set of elements along the second axis, combining the audio signals for the microphone elements in the set to create a combined output signal with a directional polar pattern;
combining the combined output signals for the third and fourth sets to generate a final output signal for all microphone elements on the second axis; and
combining the final output signal of the first axis with the final output signal of the second axis to produce a final combined output signal with a higher order polar pattern.

24. The method of claim 19, further comprising:
prior to generating the final output signal for all microphone elements on the first axis, applying crossover filtering to the combined output signals so that each set of elements on the first axis optimally covers the frequency band associated therewith.

25. The method of claim 24, wherein the plurality of microphone elements further comprises a fifth set of elements including at least two microphone elements spaced apart from each other by a third distance along the first axis, the third distance being larger than the second distance, so that the second set is nested within the fifth set, wherein the third distance is selected to configure the fifth set for optimal microphone operation in a third frequency band that is lower than the second frequency band, and
wherein applying crossover filtering includes applying a bandpass filter to the combined output signal of the second set, applying a low pass filter to combined output signal of the fifth set, and applying a high pass filter to the combined output signal of the first set.

26. The method of claim 19, wherein each microphone element is a micro-electrical mechanical system (MEMS) microphone.
